(19) United States
(12) Patent Application Publication
(10) Pub. No.: US 2018/0134296 A1
(43) Pub. Date: May 17, 2018

(54) AUTO CRUISE CONTROL METHOD FOR HYBRID ELECTRIC VEHICLES

(71) Applicants: HYUNDAI MOTOR COMPANY, SEOUL (KR); KIA MOTORS CORPORATION, SEOUL (KR)

(72) Inventors: Ji Won OH, Hwaseong-si (KR); Jeong Soo EO, Hwaseong-si (KR); Sung Jae KIM, Suwon-si (KR)

(73) Assignees: HYUNDAI MOTOR COMPANY, SEOUL (KR); KIA MOTORS CORPORATION, SEOUL (KR)

(21) Appl. No.: 15/695,528

(22) Filed: Sep. 5, 2017

(30) Foreign Application Priority Data
Nov. 16, 2016 (KR) 10-2016-0152372

(51) Int. Cl. B60W 30/16; B60W 30/188; B60W 30/14

(52) U.S. Cl. CPC B60W 30/162; B60W 30/143; B60W 30/1882

(57) ABSTRACT

The present disclosure provides an auto cruise control method for hybrid electric vehicles including: turning on an auto cruise mode by setting, by a driver, a target vehicle speed in a hybrid electric vehicle using an engine and a driving motor as vehicle driving sources, and turning on a pulse and glide (PnG) mode, selecting any one of a PnG swing mode and a compromised PnG mode, according to vehicle state information, and executing vehicle control to drive the hybrid electric vehicle in the selected mode.

### CROSS-REFERENCE TO RELATED APPLICATION

The present application claims priority to and the benefit of Korean Patent Application No. 10-2016-0152372, filed on Nov. 16, 2016, which is incorporated herein by reference in its entirety.

### FIELD

The present disclosure relates to an auto cruise control method for hybrid electric vehicles. More particularly, it relates to an auto cruise control method to improve fuel efficiency and drivability as well.

### BACKGROUND

The statements in this section merely provide background information related to the present disclosure and may not constitute related art.

In general, an auto cruise control apparatus of a vehicle executes automatic driving of the vehicle at a predetermined vehicle speed without operation of an accelerator pedal by a driver and is thus referred to as a constant-speed driving system.

When a target vehicle speed is set by simple operation of a driver, the auto cruise control apparatus controls a vehicle so as to maintain the set target vehicle speed and thus greatly reduces operation of an accelerator pedal by the driver, thus improving driving convenience.

In the case of an internal combustion engine vehicle, such as a gasoline or diesel vehicle, when required torque (cruise torque) to maintain a target vehicle speed is determined, a conventional auto cruise control apparatus controls driving of an engine so that the required torque may be output through cooperative control between control units, and executes auto cruise to maintain the target vehicle speed thereby.

Further, in the case of an electric vehicle driven using a motor, the conventional auto cruise control apparatus controls motor torque according to required torque to maintain a target vehicle speed and, in the case of a hybrid electric vehicle driven by a motor and an engine, the conventional auto cruise control apparatus distributes power to the motor and the engine so as to output required torque.

When auto cruise is executed at a constant speed in an internal combustion engine vehicle, the operating point of an engine is determined by a vehicle speed and a transmission gear shift position regardless of an engine optimal operating line (hereinafter, referred to as “OOL”), as exemplarily shown in FIG. 1.

Accordingly, auto cruise of the internal combustion engine vehicle is disadvantageous in terms of fuel efficiency, and thus cruise control technology which may improve fuel efficiency is proposed.

For example, utility of a Pulse and Glide (hereinafter, referred to as “PnG”) driving pattern in which acceleration and deceleration of a vehicle are repeated in a designated cycle to improve fuel efficiency under real-world driving conditions is proved in various fields.

However, in the application of the known PnG cruise control, there is a tradeoff between a variation of the vehicle speed (related to drivability) and a fuel saving amount and, thus, optimal control technology which may satisfy both drivability and improvement in fuel efficiency is desired.

### SUMMARY

The present disclosure provides an auto cruise control method in which a PnG driving pattern in consideration of characteristics of hybrid electric vehicles is applied so as to improve fuel efficiency.

The present disclosure also provides an optimal auto cruise control method which may satisfy both drivability and improvement in fuel efficiency.

In one aspect, the present disclosure provides an auto cruise control method for hybrid electric vehicles, including turning on an auto cruise mode by setting, by a driver, a target vehicle speed in a hybrid electric vehicle using an engine and a driving motor as vehicle driving sources, and turning on a pulse and glide (PnG) mode, selecting any one of a PnG swing mode and a compromised PnG mode according to vehicle state information, and executing vehicle control to drive the hybrid electric vehicle in the selected mode, where, in the PnG swing mode, a pulse phase corresponding to a vehicle acceleration section and a glide phase corresponding to a vehicle deceleration section are alternately repeated between a preset upper and lower limit of vehicle speed, and driving of the hybrid electric vehicle is performed in the glide phase by inertia of the hybrid electric vehicle, and, in the compromised PnG mode, a pulse phase corresponding to a vehicle acceleration section and a glide phase corresponding to a vehicle deceleration section are alternately repeated between the preset upper and lower limit of the vehicle speed, acceleration of the hybrid electric vehicle is performed in the pulse phase by the engine or both the engine and the driving motor, and deceleration of the hybrid electric vehicle is performed in the glide phase by inertia of the hybrid electric vehicle and torque assistance of the driving motor.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graph illustrating the operating point of an engine during auto cruise driving of an internal combustion engine vehicle;

FIG. 2 is a graph illustrating a PnG cruise driving state of a conventional general internal combustion engine vehicle;

FIG. 3 is a graph illustrating the operating point of an engine during auto cruise driving of a general hybrid electric vehicle;

FIG. 4 is a graph illustrating cruise driving states in respective PnG modes of a hybrid electric vehicle;

FIG. 5 is a block diagram illustrating a configuration of an auto cruise control system of a hybrid electric vehicle;

FIG. 6 is a flowchart illustrating an auto cruise control process of a hybrid electric vehicle;

FIGS. 7(a) and 7(b) are graphs exemplarily illustrating a real vehicle driving state according to an auto cruise control method of a hybrid electric vehicle;

FIGS. 8 and 9 are graphs exemplarily illustrating vehicle speed variations according to loads during control in a compromised PnG mode; and

FIG. 10 is a graph illustrating a comparison of respective modes

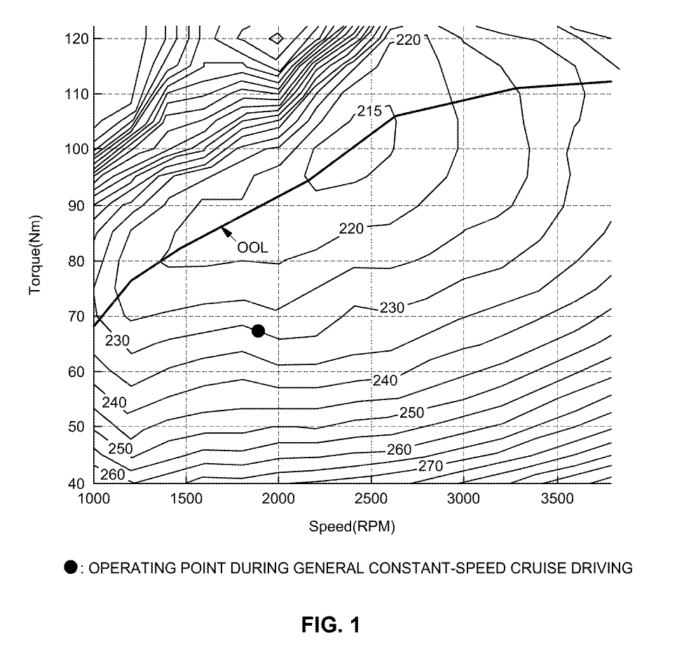

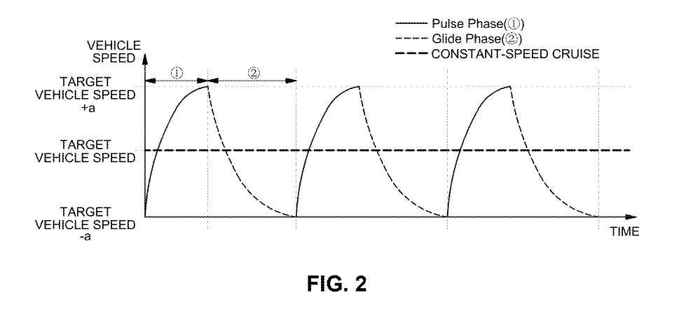

The drawings described herein are for illustration purposes only and are not intended to, limit the scope of the present disclosure in any way.

### DETAILED DESCRIPTION

The following description is merely exemplary in nature and is not intended to limit the present disclosure, application, or uses. It should be understood throughout the drawings, corresponding reference numerals indicate like or corresponding parts and features.

As prior art documents related to the present disclosure, there are U.S. Patent Publication No. 2013/0226420 (Patent Document 1) and U.S. Patent Publication No. 2013/0103238 (Patent Document 2). According to technologies disclosed in Patent Documents 1 and 2, an operating point having high efficiency on an engine brake specific fuel consumption (BSFC) map is tracked.

Patent Document 1 discloses a control apparatus and method which implement a PnG function in a general internal combustion engine vehicle and, more particularly, technology in which control to track upper and lower limit target vehicle speeds set based on a reference vehicle speed is executed during control of a vehicle speed and the target vehicle speeds are tracked through an increase and a decrease in a fuel amount of a combustion chamber.

Further, Patent Document 2 discloses an apparatus and method which improve fuel efficiency by minimizing vehicle speed fluctuation and minutely controlling a throttle value through PnG control and, more particularly, technology in which a pulse in a rapid cycle is applied to a throttle value without vehicle speed fluctuation and an engine operating point moves to an operating point having high efficiency on a BSFC map so as to improve fuel efficiency.

The present disclosure relates to a method which implements a PnG function in a hybrid electric vehicle (HEV) using an internal combustion engine and a motor as driving sources, and the object of the present disclosure is to improve fuel efficiency and to satisfy improvement in both drivability and fuel efficiency using a PnG driving pattern in consideration of characteristics of hybrid electric vehicles. In general, a hybrid electric vehicle is configured to be operated at the optimal operating point, i.e., on an engine optimal operating line (OOL), by a hybrid power optimization strategy between an engine and a motor.

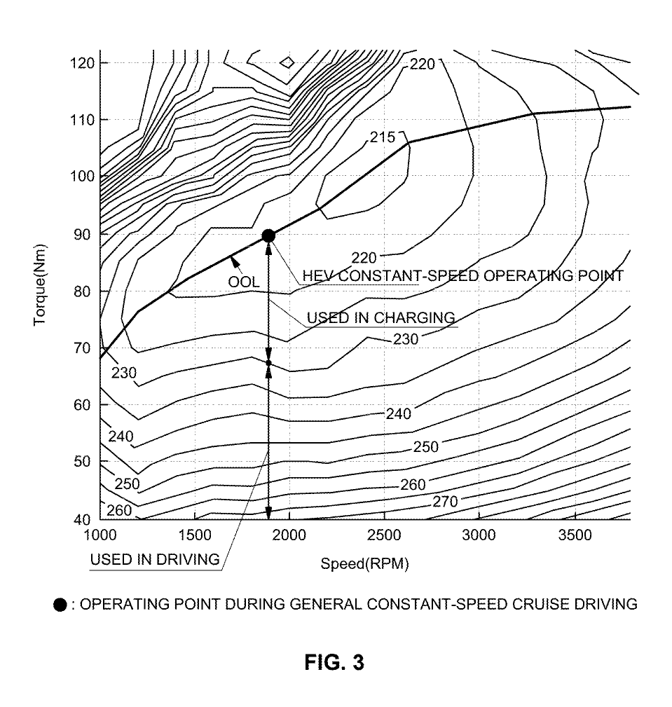

That is, during auto cruise driving of a hybrid electric vehicle at a constant speed, as exemplarily shown in FIG. 3, an operating point is determined so as to track the OOL to exert optimal efficiency and then the engine is operated. If required torque is less than engine torque complying with the optimal operating point of the OOL, an amount of the engine torque corresponding to the required torque is used to operate the vehicle, the remainder of the engine torque is applied as reverse torque (regenerative torque) to a motor operated as a generator and is thus used to charge a battery (motor regeneration and charging).

On the other hand, if the required torque is greater than the engine torque, the required torque is satisfied by motor output (motor driving torque) (motor assistance and discharging).

In FIG. 3, “operating point during general constant-speed cruise” may indicate an operating point at which a constant speed may be maintained regardless of the OOL as in a general internal combustion vehicle, and torque at such an operating point may mean the above-described required torque to maintain a constant speed.

However, the above-described constant-speed cruise strategy of the hybrid electric vehicle causes lowering of efficiency due to charging/discharging in an electrically powered system.

Therefore, if an engine operating point is determined as the optimal operating point according to a vehicle state simultaneously with reducing the use of the electrically powered system, fuel efficiency may be improved.

Based on the above aspect, in the present disclosure, during auto cruise driving of a hybrid electric vehicle, vehicle acceleration (a pulse phase) and vehicle deceleration (glide phase) are alternately repeated periodically while maintaining an average target speed, thereby improving fuel efficiency under real-world driving conditions.

The present disclosure may be applied to a Transmission Mounted Electric Device (TMED)-type hybrid electric vehicle in which a driving motor to drive the vehicle is disposed at the side of a transmission.

In a general TMED-type hybrid electric vehicle, two driving sources to drive the vehicle, i.e., an engine and a driving motor, are disposed in series, an engine clutch is disposed between the engine and the driving motor, and a transmission is disposed at the output side of the driving motor.

The engine clutch serves to connect the engine and the motor to each other so as to selectively transmit power therebetween, or to disconnect the engine and the motor from each other so as to inhibit power transmission therebetween. In a closed state of the engine clutch, the engine and the motor are connected so that power may be transmitted to driving shafts and driving wheels through the transmission.

That is, the engine clutch is disposed so as to selectively transmit power or inhibit power transmission between the engine and the driving motor and, as is well known, during driving of the vehicle in the Electric Vehicle (EV) mode, the engine clutch is opened and thus the vehicle is driven only by power of the driving motor and, during driving of the vehicle in the Hybrid Electric Vehicle (HEV) mode, the engine clutch is closed and thus the vehicle is driven by power of the engine and power of the driving motor.

Further, during braking of the vehicle or during inertial driving of the vehicle, an energy regeneration mode, in which the driving motor is operated as a power generator to charge a battery, is executed.

Further, a separate motor generator directly connected to the engine so as to transmit power to the engine, i.e., a Hybrid Starter Generator (HSG), is provided, and the HSG is operated using power of the battery and thus transmits power to the engine during starting of the engine and is operated as a power generator by rotary force transmitted from the engine and thus charges the battery during power generation.

In a general hybrid electric vehicle, various control units to control respective devices in the vehicle are provided.

That is, a hybrid control unit (HCU), an engine control unit (ECU) to control operation of an engine, a motor control unit (MCU) to control operation of a driving motor, a transmission control unit (TCU) to control operation of a transmission and an engine clutch, a battery management system (BMS) to control and manage a battery, etc. are provided, and control of the respective devices is executed through cooperative control between the control units under the control of the HCU serving as a highest-level control unit.

For example, the TCU may control clutch operating hydraulic pressure according to a control command from the HCU, and thus close or open the engine clutch.

In the present disclosure, such cooperative control between the control units may be executed during vehicle speed control processes in the respective modes during auto cruise driving, and operations of the engine, the driving motor, the transmission and the engine clutch are controlled by the corresponding control units.

Although the above description states a plurality of control units to control respective devices in the vehicle, an integrated control means may be used instead of the control units and, in the specification, both the control units and the integrated control means will be commonly called control units.

First, an auto cruise control mode in the present disclosure includes a PnG mode which is executed by turning on the PnG mode under the condition that a driver turns on the auto cruise control mode by setting a target vehicle speed, and the PnG mode includes a plurality of subdivided driving modes which may be selected based on vehicle state information, such as a State of Charge (SoC) of a battery, a vehicle acceleration, etc.

That is, the PnG mode in the present disclosure may include a plurality of subdivided driving modes, i.e., a PnG constant-speed cruise mode (PnG_const), a PnG swing mode (PnG_swing) and a compromised PnG mode (Compromised PnG).

Here, the PnG swing mode (PnG_swing) may be divided into a first PnG swing mode (PnG_swing_ideal) corresponding to an ideal driving mode, in which vehicle dynamic characteristics and a transient state are not reflected and considered, and a second PnG swing mode (PnG_swing_real) corresponding to a real driving mode, in which the vehicle dynamic characteristics and the transient state are reflected and considered.

For example, the PnG mode may be subdivided into four modes, i.e., the PnG constant-speed cruise mode (PnG_const), the first PnG swing mode (PnG_swing_ideal), the second PnG swing mode (PnG_swing_real), and the compromised PnG mode (Compromised PnG).

Since the first PnG swing mode (PnG_swing_ideal) is an ideal driving mode in which the vehicle dynamic characteristics and the transient state are not reflected and considered, the first PnG swing mode (PnG_swing_ideal) is not actually applied as the PnG mode in the present disclosure. Hereinafter, the PnG swing mode (PnG_swing) means the second PnG swing mode (PnG_swing_real).

In summary, the PnG mode in the present disclosure may include three driving modes, i.e., the PnG constant-speed cruise mode (PnG_const), in which the vehicle is driven while constantly maintaining a target vehicle speed set by a driver, the PnG swing mode (PnG_swing), in which vehicle acceleration (the pulse phase) and deceleration (the glide phase) are alternately repeated periodically and, in the glide phase, the transmission is in the neutral position, the engine clutch is opened and coasting of the vehicle in the fuel cut state of the engine (driving of the vehicle by inertia of the vehicle) is executed, and the compromised PnG mode (Compromised PnG), in which vehicle acceleration (the pulse phase) and deceleration (the glide phase) are alternately repeated periodically and, in the glide phase, deceleration of the vehicle is carried out along a speed profile set by inertia of the vehicle and power of the driving motor.

Hereinafter, the PnG swing mode is referred to as a first PnG mode, the compromised PnG mode is referred to as a second PnG mode, and the PnG constant-speed cruise mode is referred to as a third PnG mode.

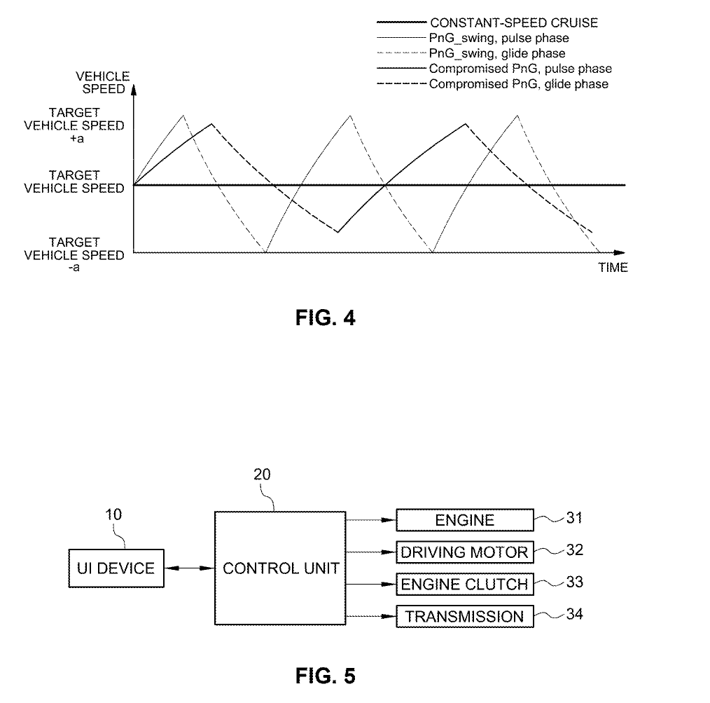

FIG. 4 is a graph illustrating cruise driving states in the respective PnG modes of a hybrid electric vehicle in accordance with the present disclosure.

In the third PnG mode (PnG_const), general constant-speed cruise of the hybrid electric vehicle is carried out and a target vehicle speed set by a driver is constantly maintained.

Since a constant vehicle speed is maintained in the third PnG mode (PnG_const), the third PnG mode (PnG_const) is a driving mode having the highest drivability, and, in order to maintain a constant vehicle speed, general constant-speed cruise control of the hybrid electric vehicle described with reference to FIG. 3 is executed.

In the third PnG mode (PnG_const), hybrid power of the engine and the driving motor is used under the condition that the engine clutch is closed, and driving control tracking the OOL is carried out (the OOL driving strategy is maintained).

While, in order to maintain a constant speed during constant-speed cruise driving of an internal combustion engine vehicle, an operating point, at which required torque may be satisfied, is determined as an engine operating point regardless of the OOL, during general constant-speed cruise driving of a hybrid electric vehicle, an operating point on the OOL is determined as an engine operating point and an electrically powered system including a driving motor is partially used.

Therefore, in the third PnG mode (PnG_const), lowering of efficiency due to loss in the electrically powered system and charging/discharging occurs but desired load within a broad speed range may be satisfied.

Next, in the first PnG mode (PnG_swing) and the second PnG mode (Compromised PnG), a driving pattern is set to alternately repeat vehicle acceleration (pulse phase) and deceleration (glide phase). The first PnG mode (PnG_swing) and the second PnG mode (Compromised PnG) are different in terms of control of the pulse phase and the glide phase.

In more detail, the first PnG mode (PnG_swing) and the second PnG mode (Compromised PnG) are the same in that desired power in the pulse phase is increased so as to execute vehicle acceleration.

Further, in the pulse phase of the first PnG mode (PnG_swing), only power of the engine is used to accelerate the vehicle and driving of the motor, assistance (discharging) and regeneration of the motor are not executed.

Therefore, in the pulse phase of the first PnG mode (PnG_swing), the electrically powered system is not used and thus loss due to the electrically powered system does not occur during charging/discharging.

Further, in the pulse phase of the first PnG mode (PnG_swing), an operating point on the OOL is determined as an engine operating point but, in the pulse phase of the second PnG mode (Compromised PnG), an optimal operating point on a Brake Specific Fuel Consumption (BSFC) map, i.e., a Sweet Spot (hereinafter referred to as an “SS”), is determined as an engine operating point.

Here, in the pulse phase of the first PnG mode (PnG_swing), an engine operating point is determined so as to track the OOL, and engine output and the operating point vary due to the non-use state of the electrically powered system (PE). However, in the pulse phase of the second PnG mode (Compromised PnG), if the SS is determined as an engine operating point, engine driving control is carried out using the SS as the engine operating point and, thus, the engine operating point and engine output are fixed.

In the pulse phase of the second PnG mode (Compromised PnG), a part of surplus power of the engine may be absorbed through regenerative operation of the electrically powered system including the driving motor.

The SS is an operating point having the minimum fuel consumption rate on the BSFC map indicating fuel consumption rate information expressed in contour lines and, as BSFC is in inverse proportion to engine efficiency, the SS is a point having the maximum engine efficiency of the hybrid electric vehicle.

In a case of the above-described first PnG swing mode (PnG_swing_ideal), the SS is determined as an engine operating point in the pulse phase and coasting is carried out in the glide state under the condition that the engine is stopped and the engine clutch is opened and, thus, the hybrid electric vehicle may be driven at an operating point having theoretically highest efficiency.

Such a first PnG swing mode (PnG_swing_ideal) corresponds to an ideal driving state in which vehicle dynamic characteristics and a transient state are not considered, and a vehicle speed variation is relatively increased in a direction towards a lower power region and has a negative influence on drivability.

In a case of the second PnG swing mode (PnG_swing_real) actually applied as the PnG swing mode (i.e., the first PnG mode) in the present disclosure, an SS tracking limit due to a fixed gear ratio, the vehicle dynamic characteristics and the transient state are considered and thus efficiency is lowered.

Since the SS is an operating point having the minimum fuel consumption rate and the maximum engine efficiency, in the first PnG mode (PnG_swing) in which an operating point on the OOL is determined, operating point loss (engine efficiency loss) may occur but optimal efficiency within a broad range may be maintained in comparison to the second PnG mode (Compromised PnG) in which the SS is determined as the operating point in the pulse phase.

Further, in the pulse phase of the second PnG mode (Compromised PnG), the SS having the minimum fuel consumption rate is determined as an engine operating point (the engine operating point and engine output are fixed as the SS) and, thus, in the pulse phase, the hybrid electric vehicle is in a gently acceleration state, i.e., is relatively gently accelerated, and has a relatively small acceleration degree, as compared to in the first PnG mode (PnG_swing) in which an engine operating point is determined so as to track the OOL (the operating point varies along the OOL and engine output varies).

The above state is the same in the glide phase, which will be described later, in the second PnG mode (Compromised PnG), the hybrid electric vehicle is in a gentle deceleration state, i.e., is relatively gently decelerated, and has a relatively small deceleration degree, as compared to in the first PnG mode (PnG_swing).

The glide phases of the first PnG mode (PnG_swing) and the second PnG mode (Compromised PnG) are the same in that the engine is stopped in the fuel cut state and the engine clutch is opened to decelerate the vehicle.

In more detail, in the glide phase of the first PnG mode (PnG_swing), the vehicle driving source generates no power (the engine is stopped in the fuel cut state), coasting of the vehicle is carried out only by inertia so that the vehicle is decelerated, the driving motor generates no power and, thus, no electrical energy to drive the vehicle is consumed.

Here, since the engine clutch is opened, the transmission is in the neutral position, regeneration is not executed, and the electrically powered system is not used.

In both the pulse phase and the glide phase of the first PnG mode (PnG_swing), the electrically powered system including the driving motor is not used and thus loss due to the electrically powered system does not occur.

On the other hand, in the glide phase of the second PnG mode (Compromised PnG), torque assistance of the driving motor is carried out so that the driving range of the vehicle during deceleration may be increased by consuming a small amount of energy in the vehicle, differently from in the glide phase of the first PnG mode (PnG_swing).

Particularly, during deceleration of the second PnG mode (Compromised PnG), power of the driving motor is transmitted to the driving shafts and the driving wheels through the transmission (the transmission is controlled in the in-gear state) and thus the vehicle is decelerated at a gentle deceleration gradient (i.e., a lower deceleration rate), as compared to during deceleration of the vehicle in the first PnG mode (PnG_swing).

For example, differently from during deceleration of the first PnG mode (PnG_swing) in which the vehicle is driven only by inertia, during deceleration of the second PnG mode (Compromised PnG), a designated amount of required torque is generated so as to control the vehicle speed during deceleration and the motor executes torque assistance equal to the amount of desired torque, thus extending a driving range.

Motor torque assistance, in which the motor generates and outputs driving force corresponding to a torque assistance amount by the motor and the vehicle is decelerated by force acquired by adding the driving force of the motor (i.e., torque assistance force) to inertial force of the vehicle, is carried out and, therefore, the vehicle is decelerated at a slow deceleration rate by the torque assistance force by the motor applied in the deceleration state, as compared to during deceleration of the vehicle in the first PnG mode (PnG_swing).

Torque assistance in the glide phase, means, not accelerating the vehicle by torque assistance, but use of motor power so as to decelerate the vehicle using a speed profile having a gentle deceleration gradient, as compared to the glide phase in which vehicle deceleration is carried out only by inertia.

Therefore, deceleration of the vehicle in the second PnG mode (Compromised PnG) causes consumption of energy in the vehicle, as compared with deceleration of the vehicle in the first PnG mode (PnG_swing), but has an increased driving range and excellent drivability.

Thus, the second PnG mode (Compromised PnG) may be referred to as a mode in which there is a compromise between driving power of the first PnG mode (PnG_swing) and driving power of the third PnG mode (PnG_const) and, in the second PnG mode (Compromised PnG), both high efficiency of the first PnG mode (PnG_swing) and excellent drivability of the third PnG mode (PnG_const) may be partially acquired.

Consequently, in the glide phase of the second PnG mode (Compromised PnG), the vehicle does not maintain a vehicle speed as high as in the third PnG mode (PnG_const) but is not decelerated as much as in the first PnG mode (PnG_swing).

Further, even in the pulse phase of the second PnG mode (Compromised PnG), a part of engine output is converted into electrical energy through motor regeneration and stored in the battery and, thereby, the vehicle does not maintain a vehicle speed as high as in the third PnG mode (PnG_const) but is not accelerated as much as in the first PnG mode (PnG_swing).

In terms of drivability, the third PnG mode (PnG_const), in which the vehicle maintains a constant vehicle speed, has the highest drivability, and the second PnG mode (Compromised PnG), in which the vehicle is accelerated and decelerated at a relatively gentle rate in the pulse phase and glide phase, has higher drivability than the first PnG mode (PnG_swing), in which the vehicle is rapidly accelerated and decelerated in the pulse phase and glide phase.

In the present disclosure, auto cruise driving is controlled in any one of the above three modes, i.e., the third PnG mode (PnG_const), the first PnG mode (PnG_swing) and the second PnG mode (Compromised PnG), by mode selection by a driver, and a control unit 20 executes predetermined control of respective devices in the vehicle according to each mode.

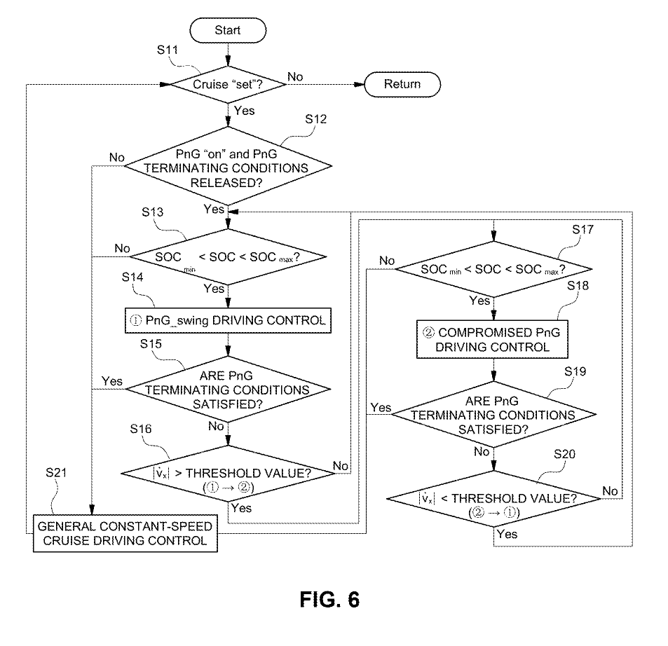

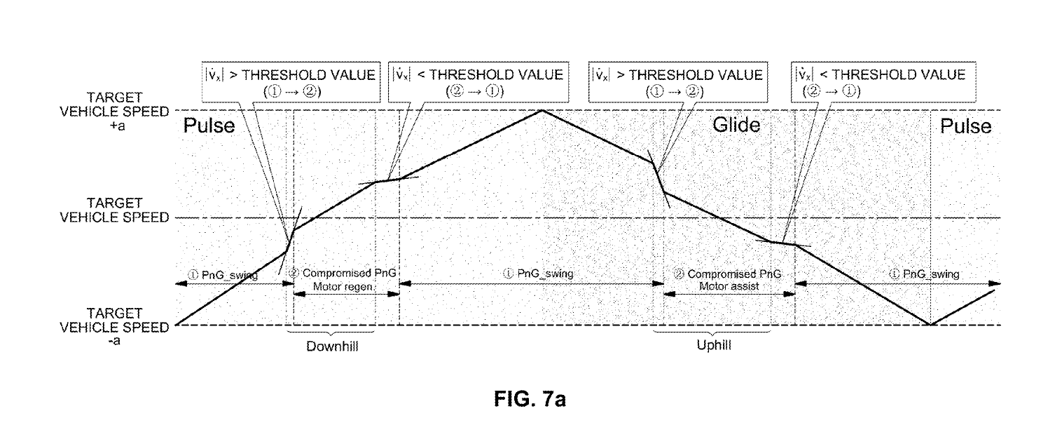

FIG. 5 is a block diagram illustrating the configuration of an auto cruise control system of a hybrid electric vehicle in accordance with the present disclosure, and FIG. 6 is a flowchart illustrating an auto cruise control process of a hybrid electric vehicle in accordance with the present disclosure.

With reference to FIGS. 5 and 6, an auto cruise control process will be described. When a driver sets a target vehicle speed through a user interface (UI) device 10 and then turns on the PnG mode (Operations S11 and S12), in order to execute any one of the above-described modes subdivided from the PnG mode, the control unit 20 executes control of an engine 31, a driving motor 32, an engine clutch 33, a transmission 34, etc., for example, executes control of fuel supply to the engine 31 (including fuel cut), control of closing or opening of the engine clutch 33, control of the gear position of the transmission 34 (including the neutral position), etc.

Basically, driving of the vehicle in the PnG mode is carried out under the condition that the driver turns on both the auto cruise control mode and the PnG mode. The auto cruise control mode may be turned on by setting a target vehicle speed by operating a user interface (UI) device 10 in the vehicle, such as a button or a switch, by the driver (cruise “set”). This means that operation of auto cruise control is selected by the driver, and the control unit 20 receives a signal from the UI device 10 according to driver's operation and thus recognizes that the auto cruise function is turned on by the driver.

Further, the PnG mode may also be turned on by operating a user interface (UI) 10 in the vehicle, such as a button or a switch, by the driver (PnG “on”). This means that operation of the PnG mode control is selected by the driver, and the control unit 20 receives a signal from the UI device 10 according to driver's operation and thus recognizes that the PnG function is turned on by the driver.

Of course, in the vehicle, the UI device 10 or operation to turn on/off the auto cruise function should be distinguished from the UI device 10 or operation to turn on/off the PnG function.

As described above, when the driver sets a target vehicle speed, the control unit 20 determines an upper limit target vehicle speed (“target vehicle speed +a” in FIG. 4) and a lower limit target vehicle speed (“target vehicle speed −a” in FIG. 4) and controls the vehicle to be accelerated and decelerated between the upper limit target vehicle speed and the lower limit target vehicle speed in the first PnG mode (PnG_swing) and the second PnG mode (Compromised PnG), which will be described later (with reference to FIG. 4).

Here, ‘a’ to determine the upper limit target vehicle speed and the lower limit target vehicle speed from the target vehicle speed set by the driver has a predetermined value.

Further, if the PnG mode is not turned or terminating conditions of the PnG mode are maintained under the condition that the auto cruise control mode is turned on, a known general constant-speed cruise mode of hybrid electric vehicles, i.e., general constant-speed driving control in which the vehicle maintains a target vehicle speed set by the driver, is executed (Operation S21).

If the terminating conditions of the PnG mode are released under the condition that the auto cruise mode is turned on and the PnG mode is turned on, the control unit 20 confirms whether or not the current SoC of the battery is within a set range (Operation S13) and, if the current SoC of the battery deviates from the set range, driving of the vehicle is controlled in the third PnG mode (Operation S21).

The third PnG mode under the condition that the PnG mode is turned on is the same as the general constant-speed cruise mode of hybrid electric vehicles in that general constant-speed driving control in which the vehicle maintains a target vehicle speed set by the driver, is executed.

If the current SoC of the battery is within the set range in Operation S13, the control unit 20 selects the first PnG mode (Operation S14) and driving of the vehicle is controlled in the first PnG mode.

If designated PnG terminating conditions (including turning-off of the PnG mode by the driver) are satisfied during driving of the vehicle in the first PnG mode, the vehicle switches to the general constant-speed cruise mode (Operations S15 and S21).

Further, during driving of the vehicle in the first PnG mode, the control unit 20 continues to check whether or not the vehicle needs to switch to the second PnG mode based on the current vehicle acceleration |\dot{ν}ₓ| (Operation S16).

Here, the acceleration includes a degree of deceleration of the vehicle in the glide phase, an acceleration of the vehicle during deceleration, i.e., an acceleration of the vehicle in the glide phase is defined to have a negative value, the size of |\dot{ν}ₓ| expressed by the absolute value indicates a degree of deceleration of the vehicle, and the degree of deceleration of the vehicle increases as the absolute value increases.

Here, the control unit 20 compares the current vehicle acceleration |\dot{ν}ₓ| with a predetermined threshold value (Operation S16). If the current vehicle acceleration |\dot{ν}ₓ| is greater than the threshold value, the control unit 20 switches the vehicle to the second PnG mode under the condition that the SoC of the battery is within a set range (Operations S17 and S18) and then controls the vehicle to be driven in the second PnG mode.

Further, if the designated PnG terminating conditions (including turning-off of the PnG mode by the driver) are satisfied during driving of the vehicle in the second PnG mode, the vehicle switches to the general constant-speed cruise mode (Operations S19 and S21).

Further, during driving of the vehicle in the second PnG mode, the control unit 20 continues to check whether or not the vehicle needs to switch to the first PnG mode based on the current vehicle acceleration |\dot{ν}ₓ| (Operation 20).

That is, the control unit 20 compares the current vehicle acceleration |\dot{ν}ₓ| with a predetermined threshold value (Operation S20). If the current vehicle acceleration |\dot{ν}ₓ| is less than the threshold value, the control unit 20 switches the vehicle to the first PnG mode under the condition that the SoC of the battery is within a set range (Operations S13 and S14) and then controls the vehicle to be driven in the first PnG mode.

In the above-described control process in accordance with the present disclosure, the vehicle acceleration may be acquired from wheel speed information detected by a sensor.

In the control process of FIG. 6, |\dot{ν}ₓ| indicates the current vehicle acceleration, the threshold value is predetermined, and the threshold value in the pulse phase and the threshold value in the glide phase may be set to be equal or different.

Further, the threshold value to switch from the first PnG mode to the second PnG mode and the threshold value to switch from the second PnG mode to the first PnG mode may be set to be equal or different.

Further, the threshold value may be set to be varied according to a vehicle speed.

As such, in the present disclosure, the threshold value of the acceleration for mode switching between the first PnG mode and the second PnG mode is predetermined.

Further, in the present disclosure, even if a fuel efficiency optimization strategy is used, drivability according to loads may be satisfied. Therefore, although the driver prefers drivability, the first PnG mode is preferentially executed before the second PnG mode.

Further, in each mode, the SoC state, the PnG terminating conditions and the acceleration value are continuously monitored and, when the current acceleration value reaches each threshold value set for mode switching, the mode switching between the first PnG mode and the second PnG mode is carried out.

Further, in any mode, if the battery SoC deviates from a normal range or the PnG terminating conditions are satisfied, mode switching to the constant speed cruise mode is carried out.

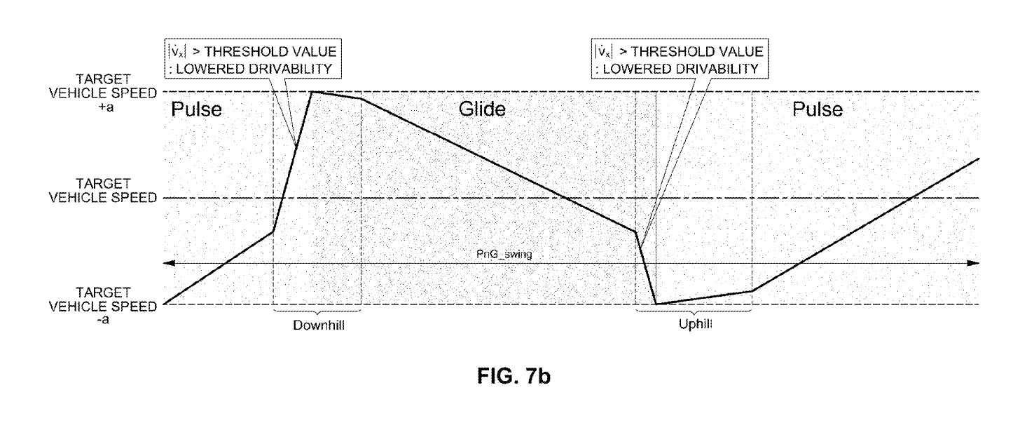

FIGS. 7(a) and 7(b) are graphs exemplarily illustrating a real vehicle driving state according to an auto cruise control method of a hybrid electric vehicle in accordance with the present disclosure, i.e., illustrating a vehicle driving state when mode switching is carried out based on a vehicle acceleration in the process of FIG. 6.

FIG. 7(a) is a graph exemplarily illustrating mode switching between the first PnG mode and the second PnG mode based on an acceleration as in the control process shown in FIG. 6, and FIG. 7(b) is a graph exemplarily illustrating driving of the vehicle only using the first PnG mode without mode switching.

With reference to FIGS. 7(a) and 7(b), if the first PnG mode and the second PnG mode are properly used together so as to execute mode switching based on an acceleration in the present disclosure, a proper vehicle acceleration may be maintained despite disturbance, such as a road surface gradient, as exemplarily shown in FIG. 7(a), thus contributing to securement of drivability.

On the other hand, if only the first PnG mode is used, a vehicle acceleration is severely varied according to disturbance, such as a road surface gradient, as exemplarily shown in FIG. 7(b), and thus drivability is lowered.

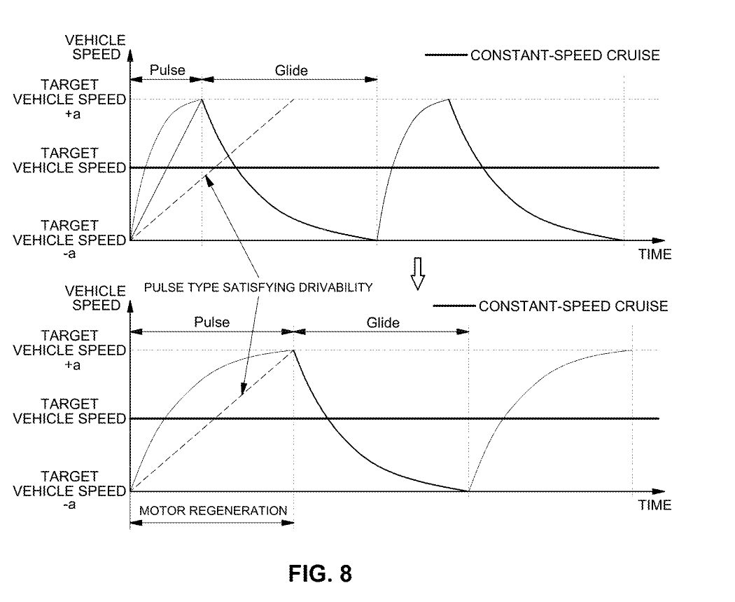

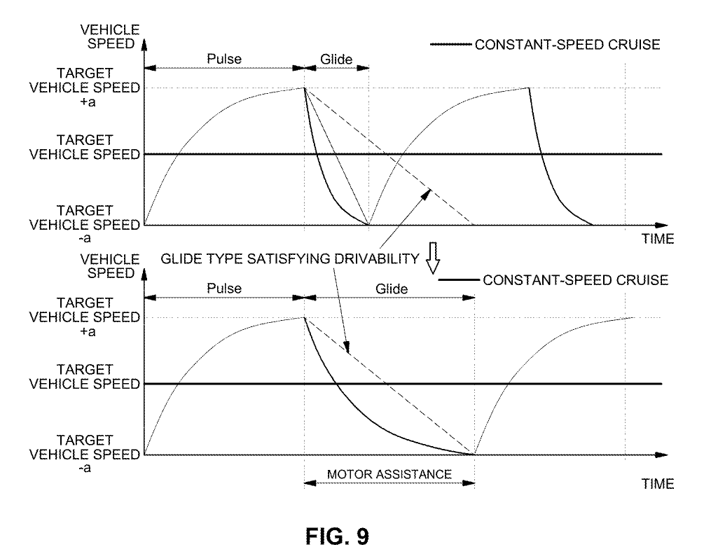

FIGS. 8 and 9 are graphs exemplarily illustrating vehicle speed variations according to loads during control in the second PnG mode in accordance with the present disclosure. The ultimate reason why the PnG mode is applied is to acquire improvement in fuel efficiency even if drivability is somewhat sacrificed.

Here, lowered drivability means that, although a driver wants to drive a vehicle at a constant speed, the vehicle is accelerated or decelerated.

On the other hand, it may be understood that excellent drivability is acquired when the vehicle is driven at a constant speed and thus the acceleration of the vehicle is maintained at 0.

Therefore, drivability of the vehicle may be determined from how far the degree of the absolute value of the vehicle acceleration deviates from 0. As the absolute value of the acceleration increases, drivability of the vehicle is lowered and, when the acceleration is maintained at 0, drivability of the vehicle is improved.

If, instead of driving in the first PnG mode to improve fuel efficiency, driving of a PnG mode having a second strategy for drivability is demanded, control to prevent the vehicle acceleration from deviating from a designated range is desired and such control is referred to as an acceleration-based PnG strategy.

With reference to FIG. 8, under low-speed conditions in which the driving load of the vehicle is low, a relatively large acceleration occurs in the pulse phase rather than in the glide phase and thus drivability is lowered. Therefore, the acceleration is restricted by lowering output in the pulse phase through regenerative braking and thus drivability is secured.

On the other hand, as exemplarily shown in FIG. 9, under high-speed conditions in which the driving load of the vehicle is high, a relatively large deceleration occurs in the glide phase rather than in the pulse phase and thus drivability is lowered. Therefore, the deceleration is lowered by compensating for output in the glide phase through motor assistance and thus drivability is secured.

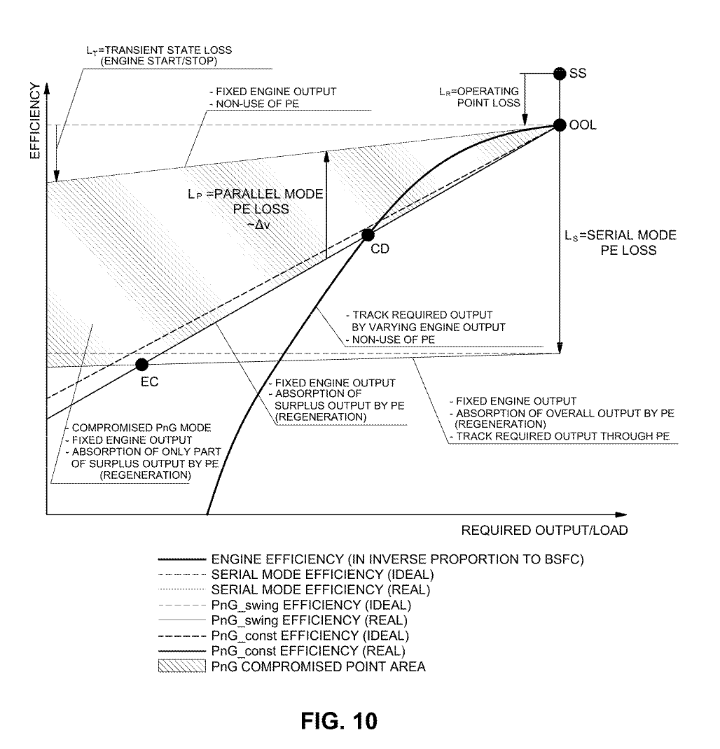

FIG. 10 is a graph illustrating a comparison between the respective modes in accordance with the present disclosure. In FIG. 10, the X-axis indicates power and the Y-axis indicates efficiency.

In the hybrid electric vehicle, a point having the maximum engine efficiency is referred to as a sweet spot SS and such a sweet spot SS represents the optimal operating point on the BSFC map.

In the first PnG swing mode (PnG_swing_ideal) which is an ideal driving mode, an engine operating point is located at the sweet spot SS in the pulse phase and the engine is stopped in the glide phase, and thus the vehicle may be theoretically driven with the improved efficiency.

Here, since the vehicle dynamic characteristics and the transient state are not considered, a variation width of the vehicle speed is relatively rapidly increased in the direction towards a lower power region and thus drivability of the vehicle is adversely affected.

On the other hand, in the second PnG swing mode (PnG_swing_ideal) which is a real driving mode, there is a sweet spot tracking limit due to a fixed gear ratio, and the vehicle dynamic characteristics and the transient state are considered and thus efficiency is lowered.

In the PnG constant-speed cruise mode (i.e., the third PnG mode) (PnG_const), an operating point is located on the OOL according to the HEV driving strategy. Here, power transmission efficiency is determined according to power distribution to the engine and the driving motor, and power used to execute charging/discharging causes lowering of efficiency.

The compromised PnG mode (i.e., the second PnG mode) (Compromised PnG) is a mode in which a compromise is struck between the driving strategies of the PnG swing mode (i.e., the first PnG mode) (PnG_swing) and the PnG constant-speed cruise mode (PnG_const), optimal acceleration and drivability may be acquired using motor regeneration and motor assistance according to vehicle loads or vehicle speed conditions in the pulse phase and the glide phase, and, particularly, in the glide phase, a part of motor assistance torque (assistance torque corresponding to required torque) is generated and thus extends a driving range.

That is, some of electrical power energy, which may be fully stored during coasting, may be directly used in the glide phase and thus drawbacks caused by lowering of circulation efficiency of electrical power energy may be supplemented.

Therefore, in the compromised PnG mode (Compromised PnG), a vehicle speed is not maintained as high as in the PnG constant-speed cruise mode (PnG_const), but vehicle acceleration and deceleration are not carried out as much as in the PnG swing mode (PnG_swing).

Consequently, through such a compromised strategy, both high efficiency, corresponding to the advantage of the PnG swing mode (PnG_swing), and high drivability, corresponding to the advantage of the PnG constant-speed cruise mode (PnG_const), may be partially acquired.

As is apparent from the above description, an auto cruise control method in accordance with the present disclosure employs a PnG driving pattern in consideration of characteristics of hybrid electric vehicles and may thus improve fuel efficiency.

Further, in the auto cruise control method in accordance with the present disclosure, the PnG mode may be subdivided into a PnG constant-speed cruise mode, a PnG swing mode and a compromised PnG mode so that a vehicle may be driven in one selected mode, which is more advantageous in terms of fuel efficiency and drivability, according to vehicle states, such as a battery SoC, an acceleration, etc., and driving of the vehicle in the compromised PnG mode is enabled so as to satisfy both drivability and improvement in fuel efficiency.

Moreover, proper mode switching between the PnG swing mode and the compromised PnG mode is carried out according to a vehicle acceleration, thereby providing improved drivability as well as improvement in fuel efficiency.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An auto cruise control method for a hybrid electric vehicle, comprising:
turning on an auto cruise control mode in the hybrid electric vehicle, wherein the hybrid electric vehicle uses an engine and a driving motor as vehicle driving sources;
selecting a selected mode in a pulse and glide (PnG) mode according to a vehicle state information, wherein the selected mode is selected between a first PnG mode and a second PnG mode; and
executing control of the hybrid electric vehicle with the selected mode, wherein:
in the first PnG mode, driving of the hybrid electric vehicle is performed in a glide phase by inertia of the hybrid electric vehicle, wherein a pulse phase and the glide phase are alternately repeated between a preset upper limit of a vehicle speed and a preset lower limit of the vehicle speed; and
in the second PnG mode, acceleration of the hybrid electric vehicle is performed in the pulse phase by the engine or both the engine and the driving motor, and deceleration of the hybrid electric vehicle is performed in the glide phase by inertia of the hybrid electric vehicle and torque assistance of the driving motor, wherein the pulse phase and the glide phase are alternately repeated between the preset upper limit of the vehicle speed and the preset lower limit of the vehicle speed.

2. The auto cruise control method for the hybrid electric vehicle of claim 1, wherein the preset upper limit of the vehicle speed is set to an upper value acquired by adding a value “a” to a target vehicle speed, and the preset lower limit of the vehicle speed is set to a lower value acquired by subtracting the value “a” from the target vehicle speed, wherein the value “a” is predetermined.

3. The auto cruise control method for the hybrid electric vehicle of claim 1, wherein the PnG mode further comprises a third PnG mode to constantly maintain the target vehicle speed using the vehicle driving sources, and wherein a selected PnG mode is selected according to the vehicle state information, and the control of the hybrid electric vehicle with the selected PnG mode is performed, wherein the selected PnG mode is selected among the first PnG mode, the second PnG mode and the third PnG mode.

4. The auto cruise control method for the hybrid electric vehicle of claim 3, wherein, in the third PnG mode, an engine operating point is determined to track an engine optimal operating line (OOL), and operation or regeneration of the driving motor is controlled, wherein the hybrid electric vehicle maintains the target vehicle speed while operating the engine at an optimal operating point of the OOL.

5. The auto cruise control method for the hybrid electric vehicle of claim 3, wherein, when the state of charge (SoC) of a battery, as the vehicle state information, deviates from a predetermined range, the third PnG mode is selected, and the control of the hybrid electric vehicle is performed to constantly maintain the target vehicle speed.

6. The auto cruise control method for the hybrid electric vehicle of claim 3, wherein, when the PnG mode is not turned on after the auto cruise control mode is turned on by setting, by the driver, the target vehicle speed, the third PnG mode is selected and the control of the hybrid electric vehicle is performed to constantly maintain the target vehicle speed.

7. The auto cruise control method for the hybrid electric vehicle of claim 3, wherein, when predetermined PnG terminating conditions including a PnG off mode are satisfied while the PnG mode is turned on and the auto cruise control mode is turned on by setting, by the driver, the target vehicle speed, the third PnG mode is selected and the control of the hybrid electric vehicle is performed to constantly maintain the target vehicle speed.

8. The auto cruise control method for the hybrid electric vehicle of claim 1, wherein, in the glide phase of the second PnG mode, generation of power from the driving motor is controlled to decelerate the hybrid electric vehicle at a gentle deceleration gradient, as compared to the glide phase of the first PnG mode.

9. The auto cruise control method for the hybrid electric vehicle of claim 1, wherein, in the glide phase of the first PnG mode, an engine clutch is disengaged, a transmission is in a neutral position, and fuel cut state of the engine is maintained, wherein the engine clutch is disposed between the engine and the driving motor.

10. The auto cruise control method for the hybrid electric vehicle of claim 1, wherein, in the glide phase of the second PnG mode, the engine clutch is disengaged, a transmission is in an in-gear state, and the fuel cut state of the engine is maintained.

11. The auto cruise control method for the hybrid electric vehicle of claim 1, wherein, in the pulse phase of the second PnG mode, the engine is controlled or both the engine and the driving motor are controlled to accelerate the hybrid electric vehicle at a gentle acceleration gradient, as compared to the pulse phase of the first PnG mode.

12. The auto cruise control method for the hybrid electric vehicle of claim 1, wherein, in the pulse phase of the first PnG mode, the engine operating point is determined to track an engine optimal operating line (OOL), wherein the engine is controlled to operate at an optimal operating point of the OOL.

13. The auto cruise control method for the hybrid electric vehicle of claim 1, wherein, in the pulse phase of the first PnG mode, the hybrid electric vehicle is accelerated only by power of the engine without use of the driving motor, wherein the engine clutch is engaged and a transmission is in the in-gear state.

14. The auto cruise control method for the hybrid electric vehicle of claim 1, wherein, in the pulse phase of the second PnG mode, a sweet spot is determined as the engine operating point and operation of the engine is controlled accordingly, wherein the sweet spot is an operating point having a minimum fuel consumption rate on a Brake Specific Fuel Consumption (BSFC) map.

15. The auto cruise control method for the hybrid electric vehicle of claim 14, wherein, in the pulse phase of the second PnG mode, simultaneously controlling the operation of the engine and operation or regeneration of the driving motor to maintain the target vehicle speed, wherein the operation of the engine is controlled by determining the sweet spot as the engine operating point.

16. The auto cruise control method for the hybrid electric vehicle of claim 1, wherein the vehicle state information is an absolute value of a vehicle acceleration and, when the absolute value of the vehicle acceleration is greater than a predetermined threshold value in the first PnG mode, the first PnG mode switches to the second PnG mode, wherein the vehicle acceleration is a degree of acceleration or deceleration of the hybrid electric vehicle.

17. The auto cruise control method for the hybrid electric vehicle of claim 1, wherein the vehicle state information is an absolute value of a vehicle acceleration and, when the absolute value of the vehicle acceleration is less than a predetermined threshold value in the second PnG mode, the second PnG mode switches to the first PnG mode.

18. The auto cruise control method for the hybrid electric vehicle of claim 16 or 17, wherein the predetermined threshold value is set in advance according to the vehicle speed, and the predetermined threshold value is updated according to the current vehicle speed.
